(19) United States
(12) Patent Application Publication
(10) Pub. No.: US 2023/0289624 A1
(43) Pub. Date: Sep. 14, 2023

(54) STORAGE MEDIUM, INFORMATION PROCESSING DEVICE, AND INFORMATION PROCESSING METHOD

(71) Applicant: Fujitsu Limited, Kawasaki-shi (JP)

(72) Inventors: Takashi KATOH, Kawasaki (JP); Kento UEMURA, Kawasaki (JP); Suguru YASUTOMI, Kawasaki (JP)

(73) Assignee: Fujitsu Limited, Kawasaki-shi (JP)

(21) Appl. No.: 18/088,825

(22) Filed: Dec. 27, 2022

(30) Foreign Application Priority Data
Mar. 10, 2022 (JP) 2022-037534

(51) Int. Cl. G06N 5/022

(52) U.S. Cl. CPC G06N 5/022

(57) ABSTRACT

A non-transitory computer-readable storage medium storing an information processing program that causes at least one computer to execute a process, the process includes acquiring an update amount of a classification criterion of a classification model in retraining, the classification model being trained by using a first dataset, the classification model classifying input data into one of a plurality of classes, the retraining being performed by using a second dataset; and detecting data with a largest change amount among the second dataset when changing each piece of data included in the second dataset so as to decrease the update amount.

### CROSS-REFERENCE TO RELATED APPLICATION

This application is based upon and claims the benefit of priority of the prior Japanese Patent Application No. 2022-037534, filed on Mar. 10, 2022, the entire contents of which are incorporated herein by reference.

### FIELD

The disclosed technology discussed herein is related to a storage medium, an information processing device, and an information processing method.

### BACKGROUND

In the field of machine learning, it may be desirable to analyze a difference between two datasets, such as a difference between a dataset used for training of a machine learning model and a dataset used at a time of applying the machine learning model. For example, it may be desirable to check the behavior of the machine learning model at the application destination by detecting the difference between the two datasets described above, or the like. For example, it may be desirable to analyze a data group that causes the difference.

As a technique related to the analysis of the machine learning model, there has been proposed a factor analysis device that quantitatively searches for factors having an impact on results based on a training result of a neural network, for example. In this device, an input node of an etiology model is set with a plurality of input values included in a dataset, and an output node is set with an output value included in the dataset. Furthermore, this device adjusts weight coefficients of a plurality of nodes included in the etiology model based on the output value and the plurality of input values, and calculates an influence value of each of a plurality of input items on the output value based on the weight coefficient adjustment result. Then, this device calculates a contribution of each of the plurality of input items to the output based on the influence value calculated based on the plurality of datasets.

Japanese Laid-open Patent Publication No. 2018-198027 is disclosed as related art.

### SUMMARY

According to an aspect of the embodiments, a non-transitory computer-readable storage medium storing an information processing program that causes at least one computer to execute a process, the process includes acquiring an update amount of a classification criterion of a classification model in retraining, the classification model being trained by using a first dataset, the classification model classifying input data into one of a plurality of classes, the retraining being performed by using a second dataset; and detecting data with a largest change amount among the second dataset when changing each piece of data included in the second dataset so as to decrease the update amount.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram of an information processing device;

FIG. 2 is a diagram for explaining comparison between datasets;

FIG. 3 is a diagram for explaining a problematic point of the comparison between the datasets;

FIG. 4 is a diagram for explaining a problematic point in detecting presence or absence of unknown data based on a confidence level according to a distance from a decision plane;

FIG. 5 is a diagram for explaining a problematic point in detecting presence or absence of unknown data based on the confidence level according to the distance from the decision plane;

FIG. 6 is a diagram for explaining a problematic point in comparing the datasets based on a change of a classification model before and after retraining;

FIG. 7 is a diagram for explaining an outline of the present embodiment;

FIG. 8 is a diagram for explaining the classification model;

FIG. 9 is a diagram for explaining calculation of a loss;

FIG. 10 is a diagram for explaining calculation of a weight update amount;

FIG. 11 is a diagram for explaining calculation of a movement amount;

FIG. 12 is a block diagram illustrating a schematic configuration of a computer that functions as the information processing device;

FIG. 13 is a flowchart illustrating an example of information processing;

FIG. 14 is a diagram for explaining a specific example of the information processing;

FIG. 15 is a diagram for explaining a specific example of the information processing;

FIG. 16 is a diagram for explaining a specific example of the information processing;

FIG. 17 is a diagram for explaining a specific example of the information processing;

FIG. 18 is a diagram for explaining a specific example of the information processing; and

FIG. 19 is a diagram for explaining a specific example of the information processing.

### DESCRIPTION OF EMBODIMENTS

At a time of applying a machine-learned model, training data used for the machine learning of the model may not remain. For example, in business using customer data, it may not be allowed to retain certain customer data for a long period of time or to reuse a machine-learned model using that customer data for a task of another customer contractually or from a perspective of a risk of information leakage. In such a case, it is not possible to detect data that causes the difference between the dataset at the time of training and the dataset at the time of application.

Furthermore, the existing technique described above is a technique related to factor analysis in the relationship between input and output, and the calculated contribution represents a feature influence level of each input on the output. For example, according to the existing technique, it is not possible to detect the data that causes the difference between the two datasets.

In one aspect, the disclosed technology aims to detect data that causes a difference between two datasets.

Hereinafter, an exemplary embodiment according to the disclosed technology will be described with reference to the drawings.

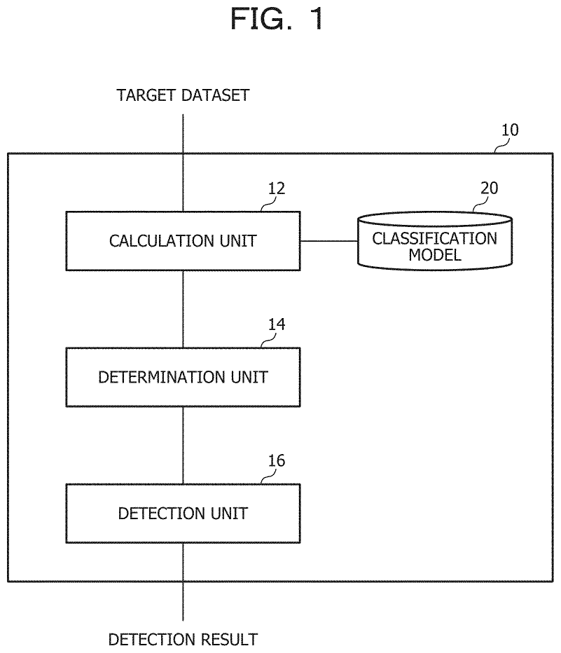

As illustrated in FIG. 1, an information processing device 10 according to the present embodiment stores a machine-learned classification model 20 that classifies input data into one of a plurality of classes. The classification model 20 is a model that has trained using a training dataset. Furthermore, a target dataset different from the training dataset is input to the information processing device 10. The target dataset may be, for example, a dataset input when a system using the classification model 20 is applied. Then, the information processing device 10 detects data that causes a difference between the training dataset and the target dataset, and outputs a detection result. Note that the training dataset is an exemplary first dataset according to the disclosed technology, and the target dataset is an exemplary second dataset according to the disclosed technology.

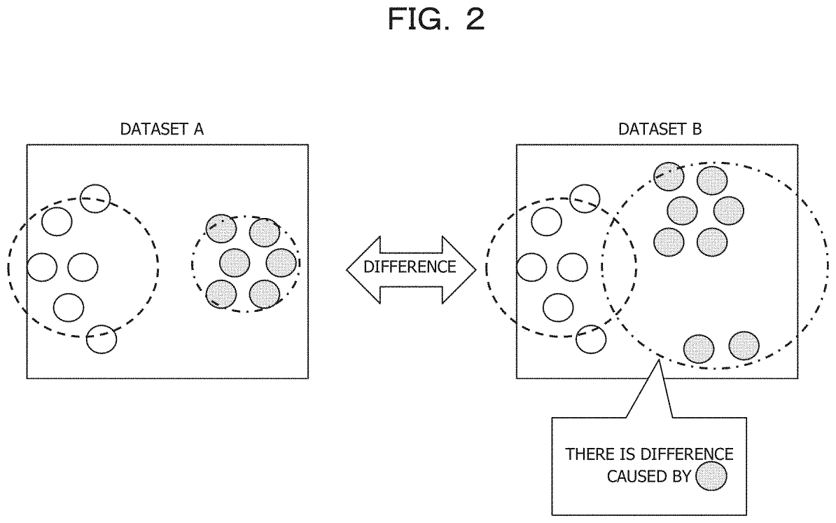

Here, as a method of analyzing the difference between the two datasets, a method of comparing statistics or the like of the two datasets and identifying presence or absence and cause of the difference is conceivable. For example, a case of comparing a difference between a dataset A and a dataset B will be described as illustrated in FIG. 2. In each of the datasets, data is grouped by a label assigned to each piece of the data, a statistic such as an average and variance of the data in a group is calculated for each group, and the calculated statistics are compared between the groups. Then, it is determined that the difference between the two datasets is caused by the data group included in the group with a statistical difference larger than a predetermined criterion. Note that each circle represents one piece of data in the example of FIG. 2. The same applies to each of the drawings below. Furthermore, in FIG. 2, the same label 1 is assigned to data represented by white circles, and the same label 2 is assigned to data represented by hatched circles.

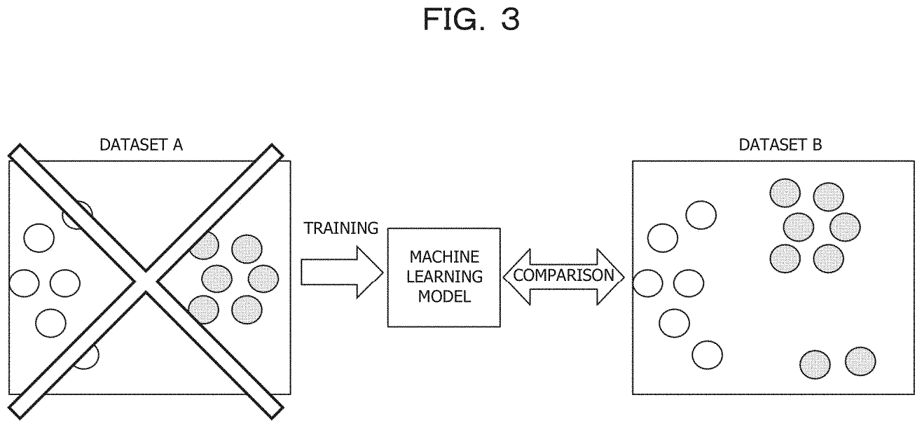

However, it is not possible to compare both datasets according to the method described above in a case where one of the datasets does not exist. For example, in a case where only a machine learning model trained with the dataset A remains and the dataset A itself does not remain as illustrated in FIG. 3, it is not possible to compare the dataset A with the dataset B. In this case, it is conceivable to compare the machine learning model trained using the dataset A with the dataset B to compare the dataset A with the dataset B.

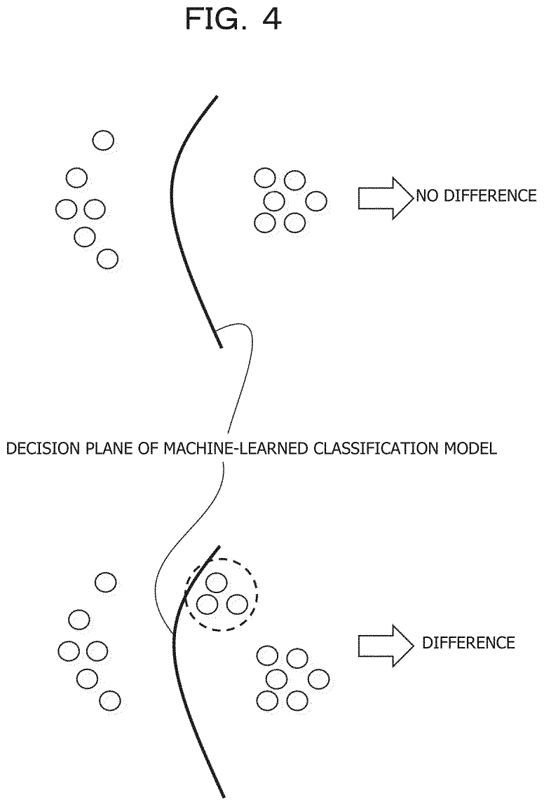

For example, a case of comparing a classification model for classifying input data into one of a plurality of classes, which is a classification model trained using a training dataset, with a target dataset different from the training dataset will be described. In this case, for a feature of the input data, a method of calculating, for each piece of target data, a confidence level based on a distance from a decision plane of a feature space indicating a boundary of individual classes in the classification model is conceivable. In this case, the confidence level that decreases as the distance from the decision plane decreases is calculated. Then, as illustrated in the upper part of FIG. 4, in a case where data with a low confidence level is less than a certain amount, no difference between the training dataset and the target dataset is detected. On the other hand, as illustrated in the lower part of FIG. 4, in a case where data with a low confidence level (broken line part in FIG. 4) exist equal to or more than the certain amount, a difference between the training dataset and the target dataset is detected.

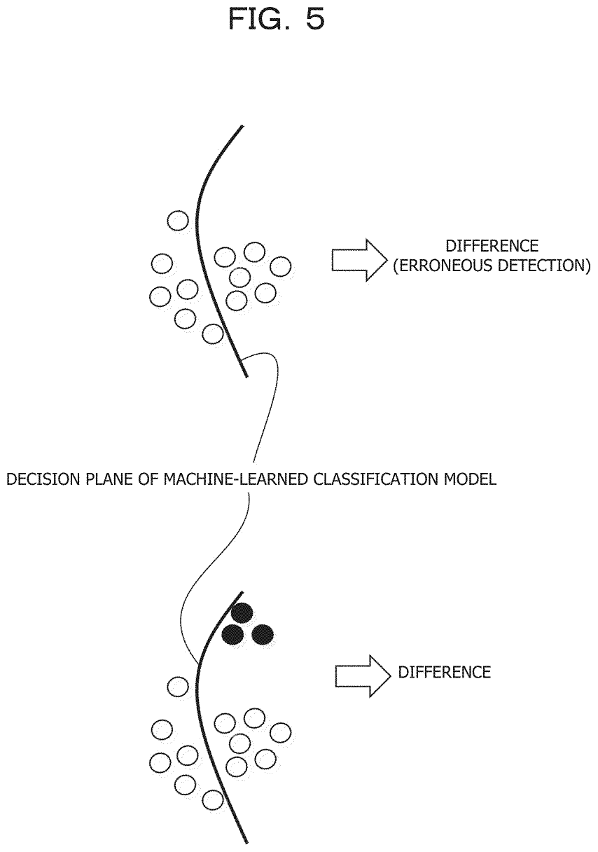

In the case of the method described above, as illustrated in the lower part of FIG. 5, a difference between the training dataset and the target dataset is detected in a case where data that actually causes the difference (black circles in FIG. 5) is included near the decision plane. However, as illustrated in the upper part of FIG. 5, a difference is erroneously detected even if data that causes the difference does not exist in a case where the target data for which the class to be classified is known is concentrated near the decision plane.

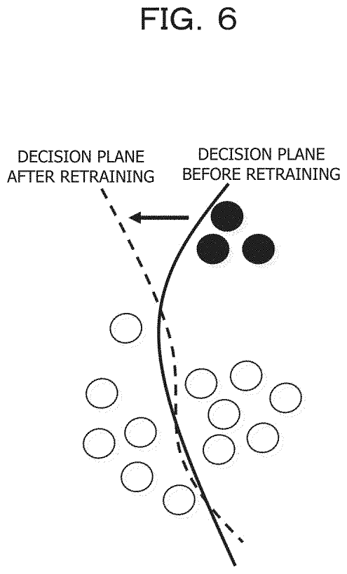

Furthermore, in a case where the classification model is retrained with the target dataset, the difference between the training dataset and the target dataset is likely to be large when a change of the decision plane of the classification model before and after the retraining is large as illustrated in FIG. 6. In view of the above, a method of assigning a label or the like to each piece of the target data included in the target dataset by any method, retraining the classification model using the target dataset, and detecting a difference from a change of the classification model before and after the retraining is also conceivable. However, this method has a problem that it takes time to detect a difference between datasets as it needs retraining of the classification model. Furthermore, although this method is capable of detecting presence or absence of a difference between datasets, data that causes the difference may not be identified.

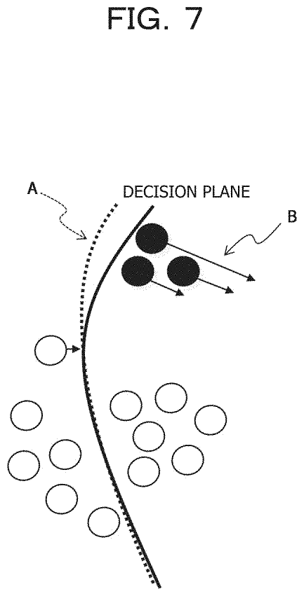

In view of the above, in the present embodiment, how the classification model is to change when retraining is carried out is estimated as indicated by A of FIG. 7 instead of comparing the classification model actually retrained with the target dataset with the classification model before the retraining. For example, it is determined whether or not the classification model changes when the retraining is carried out using an index representing an impact of a loss for the target dataset on a weight of the current classification model. This solves the problem that the retraining takes time. Furthermore, in the present embodiment, target data that needs to be largely moved when considering canceling the change of the classification model in the case of the retraining by moving individual pieces of the target data as indicated by B of FIG. 7 is identified as a cause of the difference between the datasets. Hereinafter, functional units of the information processing device according to the present embodiment will be described in detail.

As illustrated in FIG. 1, the information processing device 10 functionally includes a calculation unit 12, a determination unit 14, and a detection unit 16.

The calculation unit 12 calculates an update amount of the weight that identifies the decision plane of the classification model 20 in the case of retraining the classification model 20, which is the classification model 20 trained using the training dataset, for classifying the input data into one of the plurality of classes based on the target dataset. Note that the weight is an exemplary classification criterion according to the disclosed technology.

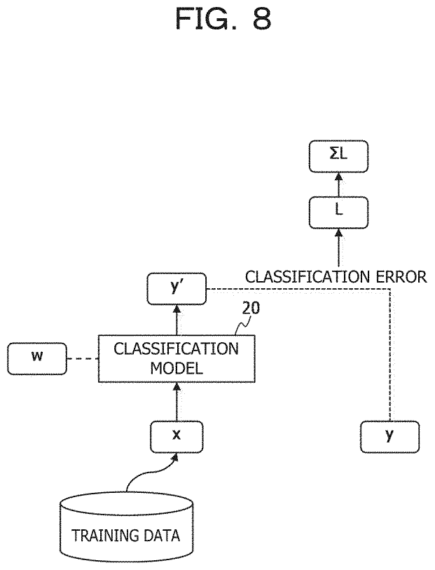

For example, as illustrated in FIG. 8, in the classification model 20, a weight w is optimized in such a manner that a total ΣL of a loss L when each piece of the training data included in the training dataset is input to the classification model 20 as input data x is minimized. The loss L is a classification error between an output y′ of the classification model 20 and a ground truth label y assigned to the training data.

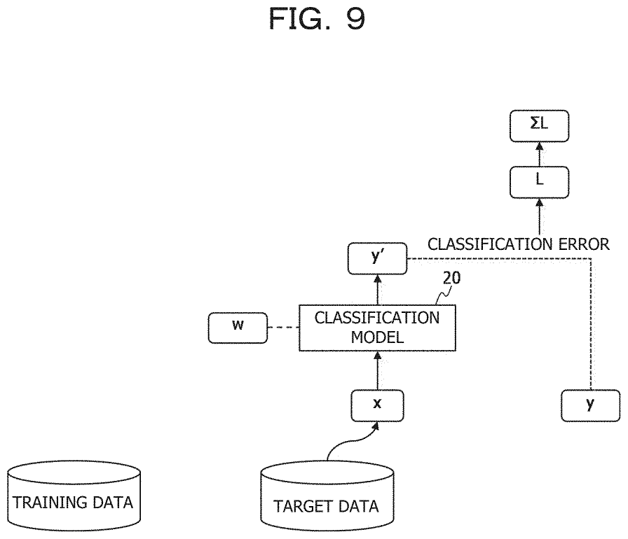

As illustrated in FIG. 9, the calculation unit 12 calculates the total IL of the loss L, which is the classification error between the output y′ and the ground truth label y, when each piece of the target data included in the target dataset is input to the classification model 20 as the input data x. When the ground truth label is not assigned to the target data, the calculation unit 12 may use a label based on the output y′ as the ground truth label y. For example, it is assumed that the output y′ is a probability that the input data belongs to each class that may be classified by the classification model 20. In this case, the calculation unit 12 may use a label indicating the class with the maximum probability represented by the output y′ for the target data (input data x) as the ground truth label y for the target data.

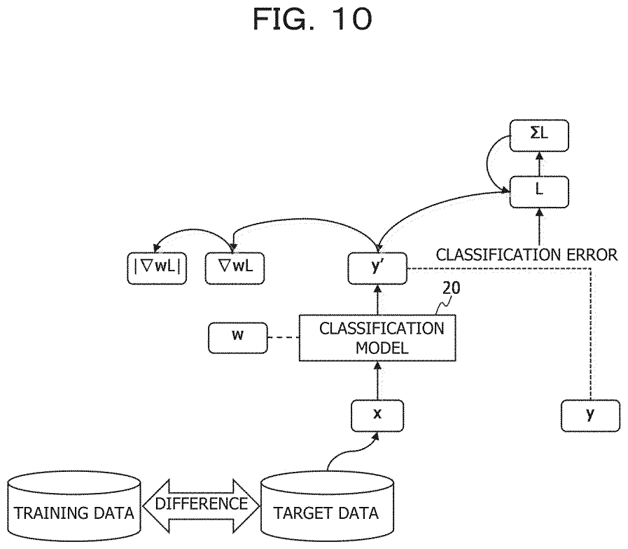

Furthermore, the calculation unit 12 calculates a weight update amount |Δw| for the total loss ΣL as an index representing the difference between the training dataset and the target dataset. Furthermore, in a case where the classification model 20 is a differentiable model such as a neural network, the calculation unit 12 may calculate, as an update amount, magnitude of a gradient indicating the impact of the loss of the classification model 20 for the target dataset on the weight. For example, as illustrated in FIG. 10, the calculation unit 12 obtains a gradient ∇wL of the weight w of the classification model 20 with respect to the total loss ΣL by backpropagation, and calculates magnitude |∇wL| of the gradient.

In a case where the update amount calculated by the calculation unit 12 is equal to or larger than a predetermined threshold value, the determination unit 14 determines that there is a difference between the training dataset and the target dataset.

When the determination unit 14 determines that there is a difference between the datasets, the detection unit 16 detects target data that causes the difference from the target dataset. For example, the detection unit 16 calculates a movement amount in a case of moving, in the feature space, each data point corresponding to the target data included in the target dataset to decrease the update amount calculated by the calculation unit 12. Note that the movement amount in the case of moving each data point corresponding to the target data in the feature space is one type of a target data change amount. Then, the detection unit 16 detects the target data whose calculated movement amount is relatively large within the target dataset as target data that causes the difference between the datasets, and outputs it as a detection result. Furthermore, the detection unit 16 may output a detection result indicating that the target data that causes the difference between the datasets is unknown data. The unknown data is data not classified into any of the plurality of classes when the target data is input to the classification model 20.

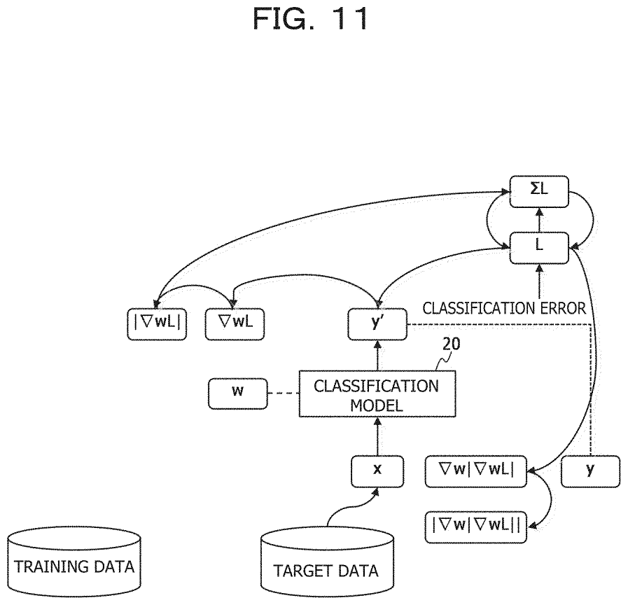

For example, the detection unit 16 considers a movement amount |Δx| of the target data in the case of moving each piece of the target data (input data x) to decrease the weight update amount |Δw| as a contribution to the difference between the datasets. Then, the detection unit 16 outputs the target data with the movement amount equal to or larger than a predetermined threshold value as a cause of the change of the classification model 20. Furthermore, in the case where the classification model 20 is a differentiable model, the detection unit 16 may calculate, as a movement amount, the magnitude of the gradient of each piece of the target data with respect to the magnitude of the gradient of the weight for the loss. For example, as illustrated in FIG. 11, the detection unit 16 calculates, for each piece of the target data, a gradient ∇x|∇wL| of the target data (input data x) with respect to the magnitude |∇wL| of the gradient and its magnitude |∇x|∇wL∥. The backpropagation (double backpropagation) may be applied to the calculation.

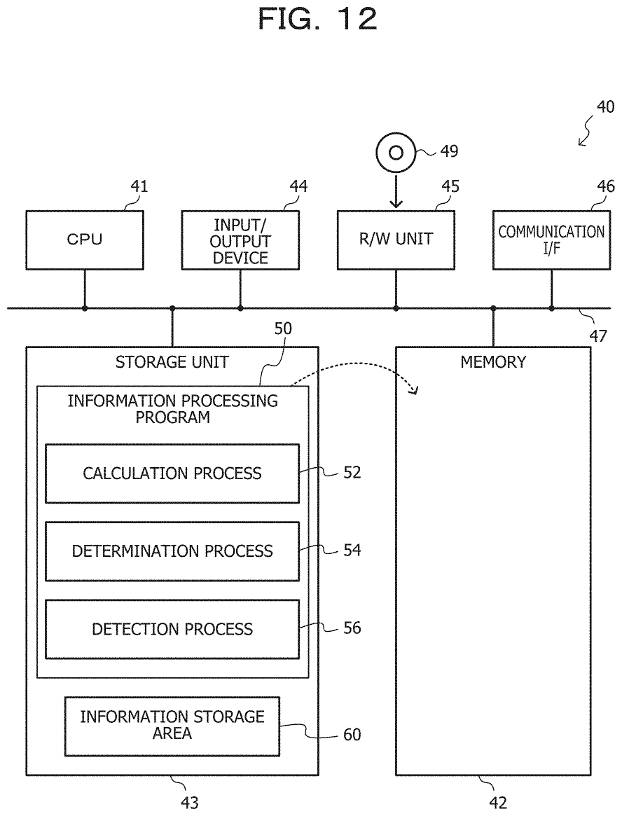

The information processing device 10 may be implemented by, for example, a computer 40 illustrated in FIG. 12. The computer 40 includes a central processing unit (CPU) 41, a memory 42 as a temporary storage area, and a nonvolatile storage unit 43. Furthermore, the computer 40 includes an input/output device 44 such as an input unit or a display unit, and a read/write (R/W) unit 45 that controls reading and writing of data from/to a storage medium 49. Furthermore, the computer 40 includes a communication interface (I/F) 46 to be connected to a network such as the Internet. The CPU 41, the memory 42, the storage unit 43, the input/output device 44, the R/W unit 45, and the communication I/F 46 are mutually connected via a bus 47.

The storage unit 43 may be implemented by a hard disk drive (HDD), a solid state drive (SSD), a flash memory, or the like. The storage unit 43 as a storage medium stores an information processing program 50 for causing the computer 40 to function as the information processing device 10. The information processing program 50 includes a calculation process 52, a determination process 54, and a detection process 56. Furthermore, the storage unit 43 includes an information storage area 60 for storing information included in the classification model 20.

The CPU 41 reads out the information processing program 50 from the storage unit 43, loads it to the memory 42, and sequentially executes the processes included in the information processing program 50. The CPU 41 executes the calculation process 52, thereby operating as the calculation unit 12 illustrated in FIG. 1. Furthermore, the CPU 41 executes the determination process 54, thereby operating as the determination unit 14 illustrated in FIG. 1. Furthermore, the CPU 41 executes the detection process 56, thereby operating as the detection unit 16 illustrated in FIG. 1. Furthermore, the CPU 41 reads out information from the information storage area 60, and loads the classification model 20 into the memory 42. This enables the computer 40 that has executed the information processing program 50 to function as the information processing device 10. Note that the CPU 41 that executes the program is hardware.

Note that, functions implemented by the information processing program 50 may also be implemented by, for example, a semiconductor integrated circuit, which is, in more detail, an application specific integrated circuit (ASIC) or the like.

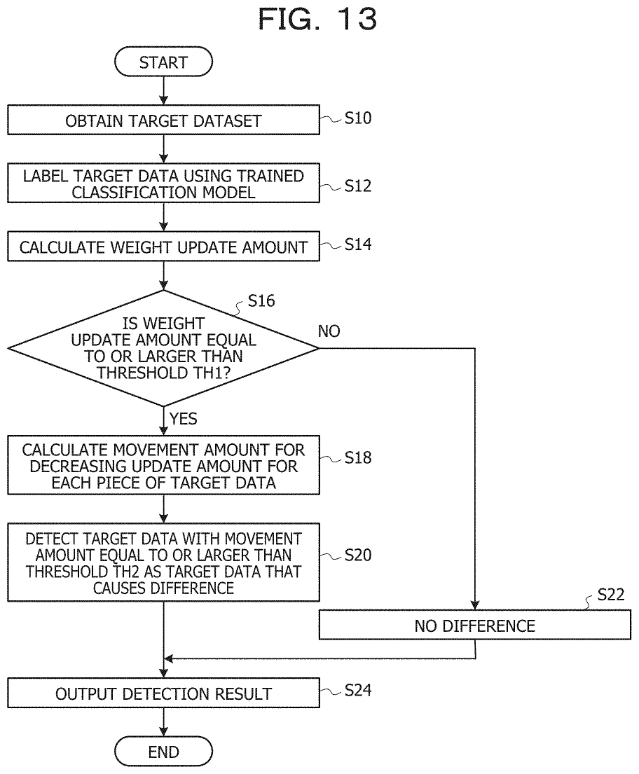

Next, operation of the information processing device 10 according to the present embodiment will be described. When the classification model 20 machine-learned with the training dataset is stored in the information processing device 10 and the target dataset is input to the information processing device 10, information processing illustrated in FIG. 13 is performed in the information processing device 10. Note that the information processing is an exemplary information processing method according to the disclosed technology.

In step S10, the calculation unit 12 obtains the target dataset input to the information processing device 10. Next, in step S12, the calculation unit 12 labels the target data based on the output obtained by inputting each piece of the target data included in the target dataset to the classification model 20. This step may be omitted if the target data is labeled in advance.

Next, in step S14, the calculation unit 12 calculates the total loss, which is a classification error between the ground truth label and the output when each piece of the target data included in the target dataset is input to the classification model 20. Then, the calculation unit 12 calculates a weight update amount of the classification model 20 with respect to the total loss.

Next, in step S16, the determination unit 14 determines whether or not the weight update amount calculated in step S14 described above is equal to or larger than a predetermined threshold value TH1. The process proceeds to step S18 if the update amount is equal to or larger than the threshold value TH1, and proceeds to step S22 if the update amount is smaller than the threshold value TH1.

In step S18, the detection unit 16 calculates a movement amount in the case of moving each piece of the target data included in the target dataset to decrease the weight update amount calculated in step S14 described above. Next, in step S20, the detection unit 16 detects target data whose calculated movement amount is equal to or larger than a predetermined threshold value TH2 as target data that causes a difference between the datasets. The threshold value TH2 may be a predetermined value, or may be a value dynamically determined to detect a predetermined number of pieces of the target data in descending order of movement amount.

Meanwhile, in step S22, the detection unit 16 determines that there is no difference between the datasets. Next, in step S24, the detection unit 16 outputs a detection result detected in step S20 described above or a detection result indicating no difference in step S22 described above, and the information processing is terminated.

Next, the information processing described above will be described more specifically using a simple example.

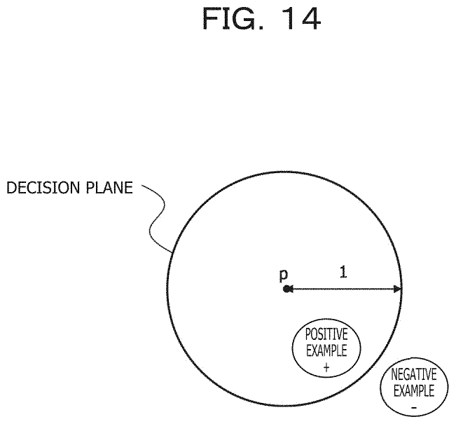

As illustrated in FIG. 14, a plane with a distance of 1 from a point p=(x, y) on a two-dimensional plane is set as a decision plane, and a model in which data with the distance of shorter than 1 from p is classified as a positive example and data with the distance equal to or longer than 1 is classified as a negative example is set as the classification model 20. The training of the classification model 20 minimizes the following total loss ΣL.

ΣL==Σᵢ exp((∥p−aᵢ∥−1)cᵢ)/N

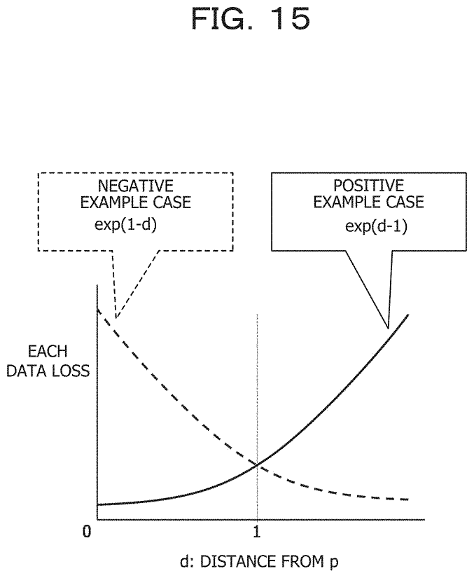

Here, aᵢ represents a two-dimensional coordinate of the i-th training data, cᵢ represents a label of the i-th training data (positive example: 1, negative example: −1), and N represents the number of pieces of the training data included in the training dataset. Furthermore, FIG. 15 illustrates a loss for each piece of the training data according to a distance d from p.

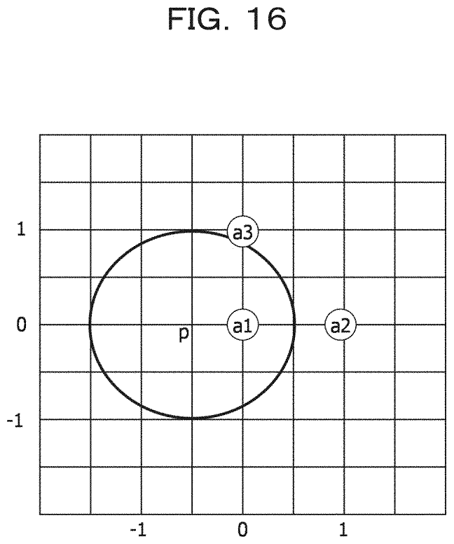

The weight in the classification model 20 is p. It is assumed that p optimized by machine learning using the training dataset is (−0.5, 0.0) as illustrated in FIG. 16. Furthermore, it is assumed that the target dataset includes the following target data a1, a2, and a3.

a1=(0.0,0.0)

a2=(1.0,0.0)

a3=(0.0,1.0)

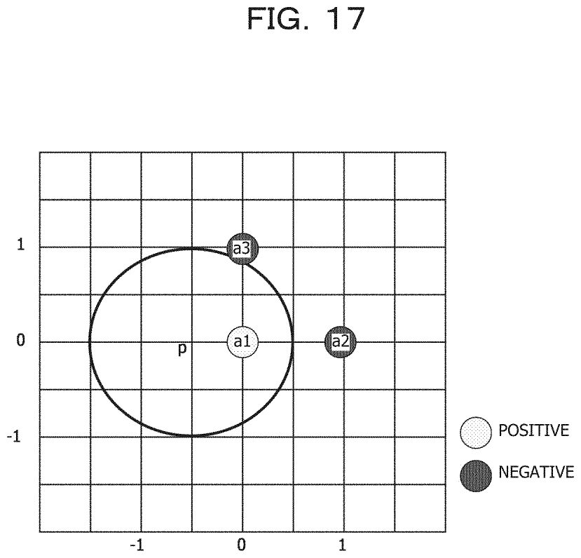

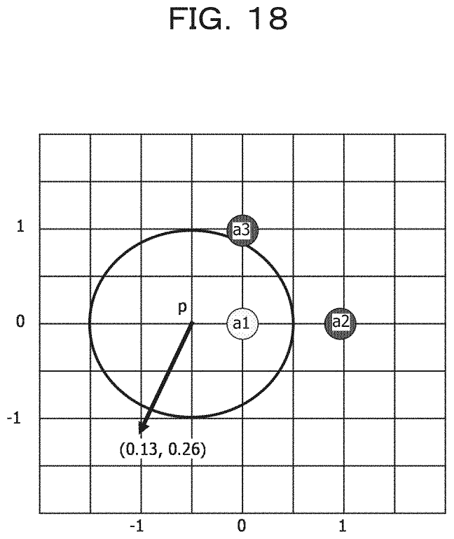

In this case, as illustrated in FIG. 17, a1 is labeled as a positive example, and a2 and a3 are labeled as negative examples. As an update amount of the weight p with respect to the loss L when those pieces of the target data are input to the classification model 20, the calculation unit 12 calculates the magnitude of the gradient of the weight p as ∥(0.13, 0.26)∥=0.30. As illustrated in FIG. 18, when the classification model 20 is retrained with the target data, the gradient of the weight p is a vector representing the direction and magnitude that p is to change. Note that FIG. 18 illustrates −5 times the gradient. Then, for example, when the threshold value TH1=0.2, the magnitude 0.30 of the gradient is equal to or larger than the threshold value TH1, and thus the determination unit 14 determines that there is a difference between the datasets.

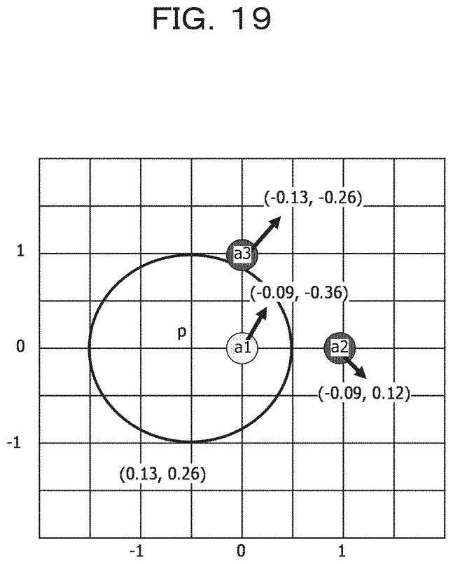

Then, the detection unit 16 calculates the gradient of each piece of the target data with respect to the magnitude of the gradient of the weight p and its magnitude as set out below and as illustrated in FIG. 19. Note that FIG. 19 illustrates −3 times the gradient.

a1:∥(−0.09,−0.36)∥=0.37

a2:∥(−0.09,0.12)∥=0.15

a3:∥(−0.13,−0.26)∥=0.30

Then, for example, when the threshold value TH2=0.2, the detection unit 16 detects the target data a1 and a3 as data that causes the difference between the training dataset and the target dataset, which is, as unknown data for the training dataset.

As described above, the information processing device according to the present embodiment calculates the update amount of the classification criterion of the classification model when the classification model trained using the training dataset, which classifies the input data into one of the plurality of classes, is retrained based on the target dataset. The target dataset is a dataset different from the training dataset. Then, the information processing device detects target data whose movement amount in the case of moving each piece of the target data included in the target dataset to decrease the calculated update amount is relatively large within the target dataset. As a result, it becomes possible to detect the data that causes the difference between the two datasets even when the training dataset does not exist.

Note that, while a mode in which the information processing program is stored (installed) in the storage unit in advance has been described in the embodiment above, it is not limited to this. The program according to the disclosed technology may also be provided in a form stored in a storage medium such as a compact disc read only memory (CD-ROM), a digital versatile disc read only memory (DVD-ROM), or a universal serial bus (USB) memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing an information processing program that causes at least one computer to execute a process, the process comprising:
acquiring an update amount of a classification criterion of a classification model in retraining, the classification model being trained by using a first dataset, the classification model classifying input data into one of a plurality of classes, the retraining being performed by using a second dataset; and
detecting data with a largest change amount among the second dataset when changing each piece of data included in the second dataset so as to decrease the update amount.

2. The non-transitory computer-readable storage medium according to claim 1, wherein the classification criterion includes a weight that specifies a decision plane that indicates a boundary of each of the classes of the classification model.

3. The non-transitory computer-readable storage medium according to claim 1, wherein the process further comprising:
determining the first dataset is different from the second dataset when the update amount is equal to or more than a certain threshold value; and
detecting the data with the largest change amount as a factor of a difference between the first dataset and the second dataset when the first dataset is different from the second dataset.

4. The non-transitory computer-readable storage medium according to claim 1, wherein the process further comprising
determining that the data with the largest change amount is unknown data not classified into one of the plurality of classes when the second dataset is input to the classification model.

5. The non-transitory computer-readable storage medium according to claim 1, wherein the acquiring includes acquiring the update amount by acquiring magnitude of a gradient that indicates an impact of a loss of the classification model for the second dataset on the classification criterion.

6. The non-transitory computer-readable storage medium according to claim 5, wherein the acquiring includes acquiring the update amount by acquiring magnitude of a gradient of each piece of the data included in the second dataset with respect to the magnitude of the gradient.

7. The non-transitory computer-readable storage medium according to claim 5, wherein the process further comprising:
assigning ground truth to each piece of the data included in the second dataset based on a classification result of each piece of the data included in the second dataset by the classification model; and
acquiring an error between the classification result of each piece of the data included in the second dataset by the classification model and the ground truth as the loss.

8. An information processing device comprising:
one or more memories; and
one or more processors coupled to the one or more memories and the one or more processors configured to:
acquire an update amount of a classification criterion of a classification model in retraining, the classification model being trained by using a first dataset, the classification model classifying input data into one of a plurality of classes, the retraining being performed by using a second dataset, and
detect data with a largest change amount among the second dataset when changing each piece of data included in the second dataset so as to decrease the update amount.

9. The information processing device according to claim 1, wherein the classification criterion includes a weight that specifies a decision plane that indicates a boundary of each of the classes of the classification model.

10. The information processing device according to claim 8, wherein the one or more processors are further configured to:
determine the first dataset is different from the second dataset when the update amount is equal to or more than a certain threshold value, and
detect the data with the largest change amount as a factor of a difference between the first dataset and the second dataset when the first dataset is different from the second dataset.

11. The information processing device according to claim 8, wherein the one or more processors are further configured to
determine that the data with the largest change amount is unknown data not classified into one of the plurality of classes when the second dataset is input to the classification model.

12. The information processing device according to claim 8, wherein the one or more processors are further configured to
acquire the update amount by acquiring magnitude of a gradient that indicates an impact of a loss of the classification model for the second dataset on the classification criterion.

13. An information processing method for a computer to execute a process comprising:
acquiring an update amount of a classification criterion of a classification model in retraining, the classification model being trained by using a first dataset, the classification model classifying input data into one of a plurality of classes, the retraining being performed by using a second dataset; and
detecting data with a largest change amount among the second dataset when changing each piece of data included in the second dataset so as to decrease the update amount.

14. The information processing method according to claim 13, wherein the classification criterion includes a weight that specifies a decision plane that indicates a boundary of each of the classes of the classification model.

15. The information processing method according to claim 13, wherein the process further comprising:
determining the first dataset is different from the second dataset when the update amount is equal to or more than a certain threshold value; and
detecting the data with the largest change amount as a factor of a difference between the first dataset and the second dataset when the first dataset is different from the second dataset.

16. The information processing method according to claim 13, wherein the process further comprising
determining that the data with the largest change amount is unknown data not classified into one of the plurality of classes when the second dataset is input to the classification model.

17. The information processing method according to claim 13, wherein the acquiring includes acquiring the update amount by acquiring magnitude of a gradient that indicates an impact of a loss of the classification model for the second dataset on the classification criterion.
